(19) United States
(12) Patent Application Publication
(10) Pub. No.: US 2018/0335599 A1
(43) Pub. Date: Nov. 22, 2018

(54) OPTICAL DEVICE WITH A FLOATING MOUNTING SHOE APPARATUS AND RELATED METHODS THEREOF

(71) Applicant: Robert J. McCreight, Boerne, TX (US)

(72) Inventor: Robert J. McCreight, Boerne, TX (US)

(21) Appl. No.: 15/971,733

(22) Filed: May 4, 2018

Related U.S. Application Data
(60) Provisional application No. 62/508,875, filed on May 19, 2017.

(51) Int. Cl. G02B 7/02; A42B 3/04; F41G 11/00

(52) U.S. Cl. CPC G02B 7/02; F41G 11/003; A42B 3/042

(57) ABSTRACT

A floating mounting shoe apparatus for use with an optical device includes a collar securable at least partially surrounding a lens bore or stop ring of an optical device. An extension arm has a first end connectable along an outer radial surface of the collar and a second end extending laterally away from the collar. The second end is positionable in an elevated, non-contacting position to the optical device when the collar is secured to the optical device. A mounting shoe is connectable to the second end of the extension arm.

### CROSS REFERENCE TO RELATED APPLICATION

This application claims benefit of U.S. Provisional Application Ser. No. 62/508,875 entitled, “Optical Device with a Floating Mounting Shoe Apparatus and Related Methods Thereof” filed May 19, 2017, the entire disclosure of which is incorporated herein by reference.

### FIELD OF THE DISCLOSURE

The present disclosure is generally related to mounting devices and more particularly is related to an optical device with a floating mounting shoe apparatus and related methods thereof.

### BACKGROUND OF THE DISCLOSURE

Optical devices are commonly used in various environments to enhance the capabilities of the user's vision. In military environments, various optical devices are used to give a soldier enhanced visibility in harsh conditions. For example, devices like the PVS 14 night vision monocular are commonly used in the military to enhance a soldier's visibility in low light conditions. These optical devices are affixed to mounting structures, such as combat helmets, weapons, or other structures that a soldier uses, and during a field operation, a soldier may move the optical device between the various mounting structures.

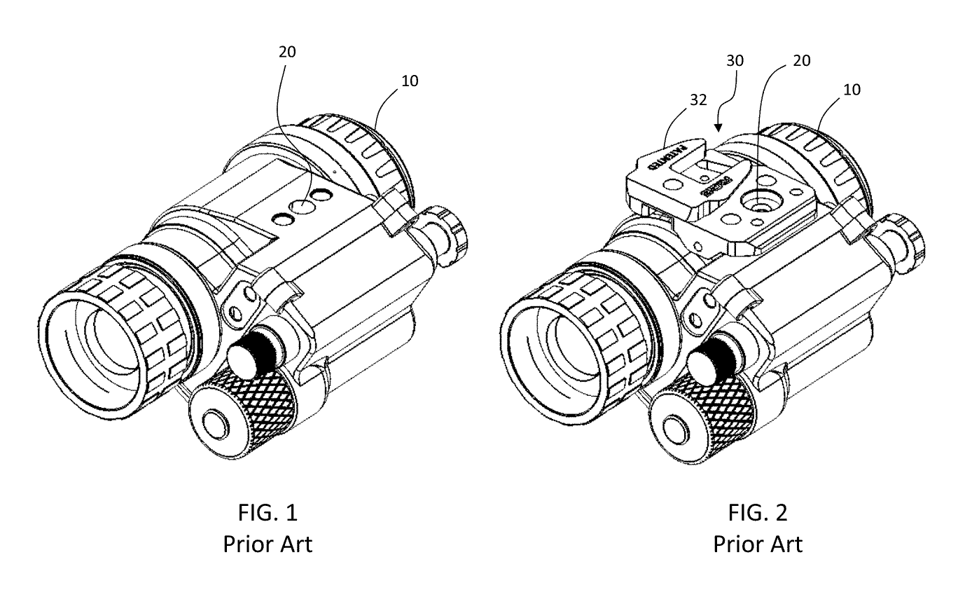

FIGS. 1-2 are illustrations of an optical device 10, in accordance with the prior art. Most optical devices 10, and in particular the PVS-14 depicted, include a threaded cavity 20 formed within the housing thereof which is sized to receive a threaded fastener (not shown), commonly a ¼-20 fastener. This threaded cavity 20 and the removable fastener have been used to mount the optical device 10 directly to a mounting structure through a threaded connection. However, this design is tedious and inefficient since it required users to threadedly engage and disengage the fastener with the cavity 20 each time the optical device 10 is to be repositioned or mounted.

To improve upon this problem, a near universal mounting shoe 30 was developed, as shown in FIG. 2, which provided a quicker means to change the position or mounting of the optical device 10. The mounting shoe 30 uses a shoe 32 with an angled, dovetail design and matching receiver, both of which have been extensively adopted in the industry. The shoe 32 is retained to the optical device 10 using the threaded cavity 20 and a fastener (not shown), such that the mounting shoe 30 is continuously carried on the optical device 10. The universality of the mounting shoe 30 allows it to he quickly and efficiently engaged or disengaged with mounting shoe receivers connected to mounting structures, such that a user need only clip or unclip the shoe 32 from the receiver in order to mount or dismount the optical device 10 from the mounting structure. The use of a shoe to secure an optical device 10 to a mounting structure, such as a combat helmet or a weapon, is well-known in the art.

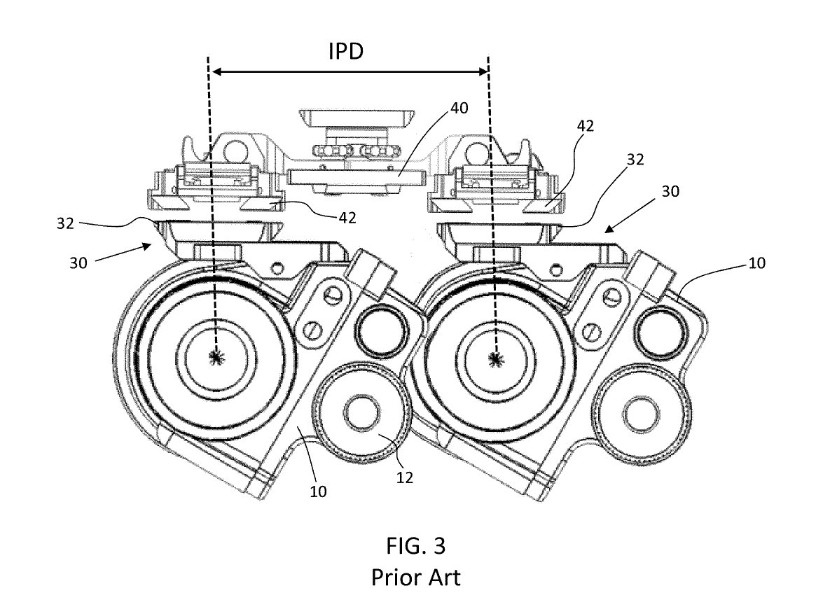

FIG. 3 is an exploded front view illustration of a bridging device 40 with two optical devices 10, in accordance with the prior art. Many users of helmet-mounted optical devices 10 want to use two optical devices 10 simultaneously in a side-by-side configuration for dual use binoculars, such that the user's vision in both eyes can receive the benefits of the optical device 10. To achieve such a configuration, users rely on a bridging device 40 which is mountable to a centrally-located helmet mount receiver and carries two shoe receivers 42 for mounting two optical devices 10. Many bridging devices 40 allow the spacing between the two shoe receivers 42 to be adjustable to meet required interpupillary distance (IPD) standards for any given users. Commonly, the minimum IPD required is 52 mm and the maximum required is 78 mm.

As one can understand from viewing FIG. 3, it is difficult if not impossible to achieve side-by-side mounting of optical devices 10 due to the width of the optical devices 10 and the required IPD. While the optical devices can theoretically be spaced at the user's desired IPD with the adjustable bridging device 40, the size of the optical devices 10 largely makes it impossible. When the optical devices are anchored with the threaded cavity 20 or a mounting shoe 30, the optical devices 10 are positioned inverted and the battery compartment 12 of one optical device 10 extends laterally and contacts the other optical device 10, as shown in FIG. 3 where the left optical device 10 is overlapping the right optical device 10. When the optical devices 10 are spaced sufficient to prevent contact therebetween, achieving an IPD within the required range is largely impossible, thus leaving the side-by-side/binocular configuration for only users with an exceptionally large IPD.

Thus, a heretofore unaddressed need exists in the industry to address the aforementioned deficiencies and inadequacies.

### SUMMARY OF THE DISCLOSURE

Embodiments of the present disclosure provide a floating mounting shoe apparatus for use with an optical device and related methods. Briefly described, in architecture, one embodiment of the apparatus, among others, can be implemented as follows. The floating mounting shoe apparatus for use with an optical device includes a collar securable at least partially surrounding a lens bore or lens stop ring of an optical device. An extension arm has a first end connectable along an outer radial surface of the collar and a second end extending laterally away from the collar. The second end is positionable in a spaced, non-contacting position to the optical device when the collar is secured to the optical device. A mounting shoe is connectable to the second end of the extension arm.

The present disclosure can also be viewed as providing a binocular mounting system. Briefly described, in architecture, one embodiment of the system, among others, can be implemented as follows. The system includes a first optical device having a first mounting shoe connected thereon. A second optical device has a collar securable at least partially surrounding at least one of a lens bore and a lens stop ring of the second optical device. An extension arm has a first end connectable along an outer radial surface of the collar and a second end extending laterally away from the collar. The second end is positionable in a spaced, non-contacting position to the second optical device when the collar is secured to the second optical device. A second mounting shoe is connected to the second end of the extension arm. A bridging device has a first receiver and a second receiver. The first optical device is connected to the first receiver by the first mounting shoe. The second optical device is connected to the second receiver by the second mounting shoe.

The present disclosure can also be viewed as providing a method of positioning two optical devices for binocular use. In this regard, one embodiment of such a method, among others, can be broadly summarized by the following steps: connecting a first mounting shoe to a body of a first optical device; connecting a second mounting shoe to at least one of: a lens bore and a lens stop ring of a second optical device; and connecting the first and second mounting shoes to a bridging device, wherein battery compartments of both optical devices are oriented away from a center of the bridging device.

Other systems, methods, features, and advantages of the present disclosure will be or become apparent to one with skill in the art upon examination of the following drawings and detailed description. It is intended that all such additional systems, zx ethods, features, and advantages be included within this description and be within the scope of the present disclosure.

### BRIEF DESCRIPTION OF THE D WINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1-2 are illustrations of an optical device, in accordance with the prior art.

FIG. 3 is an exploded front view illustration of the bridging device with two optical devices, in accordance with the prior art.

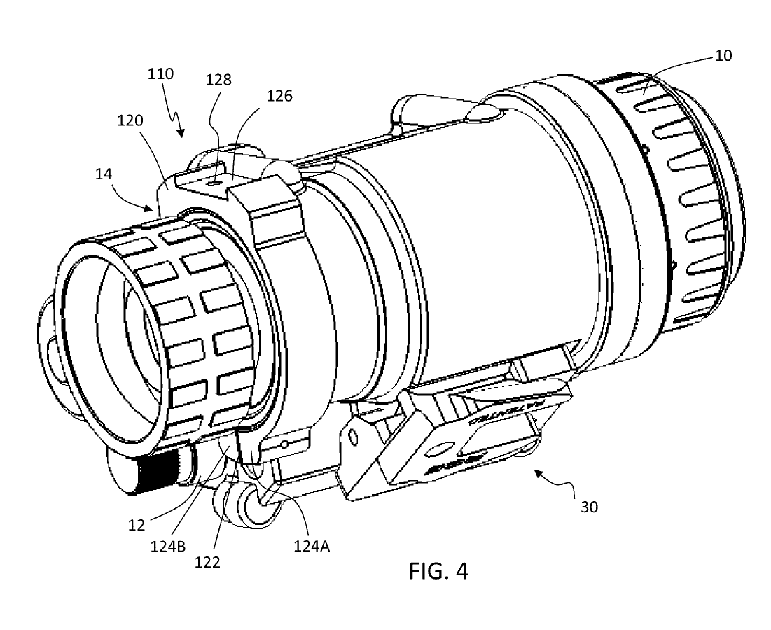

FIG. 4 is an angled side view illustration of the optical device with a floating mounting shoe apparatus, in accordance with a first exemplary embodiment of the subject disclosure.

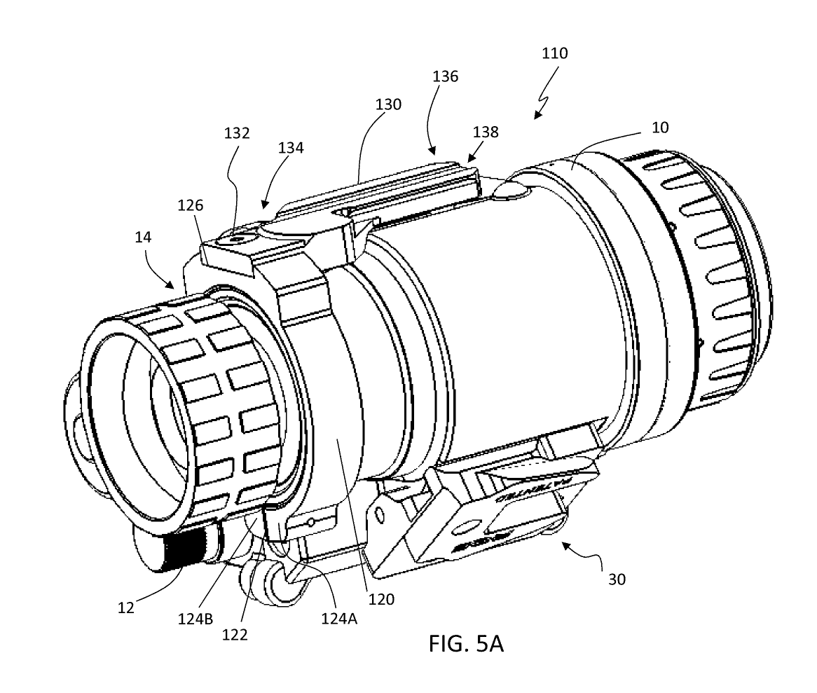

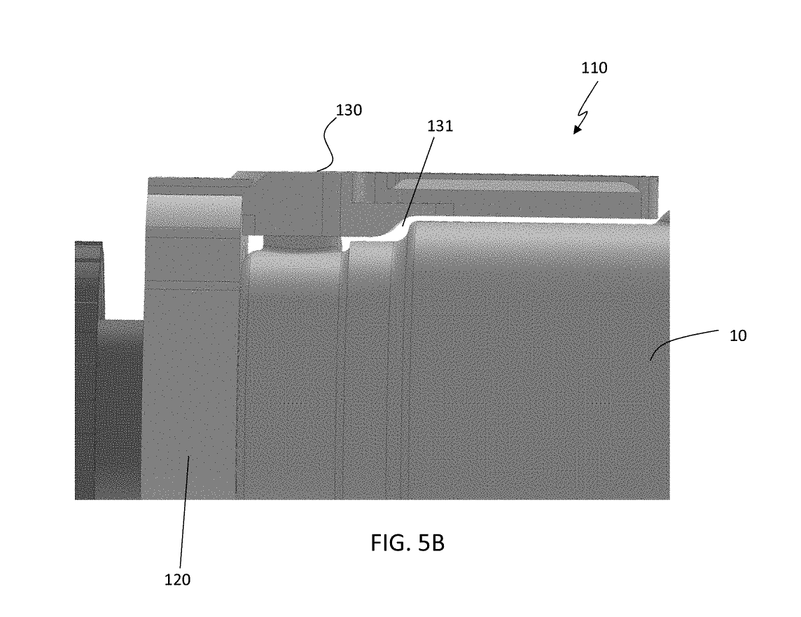

FIG. 5A is an angled side view illustration of the optical device with a floating mounting shoe apparatus of FIG. 4, in accordance with the first exemplary embodiment of the subject disclosure.

FIG. 5B is a side view illustration of the optical device with a floating mounting shoe apparatus, in accordance with the first exemplary embodiment of the subject disclosure.

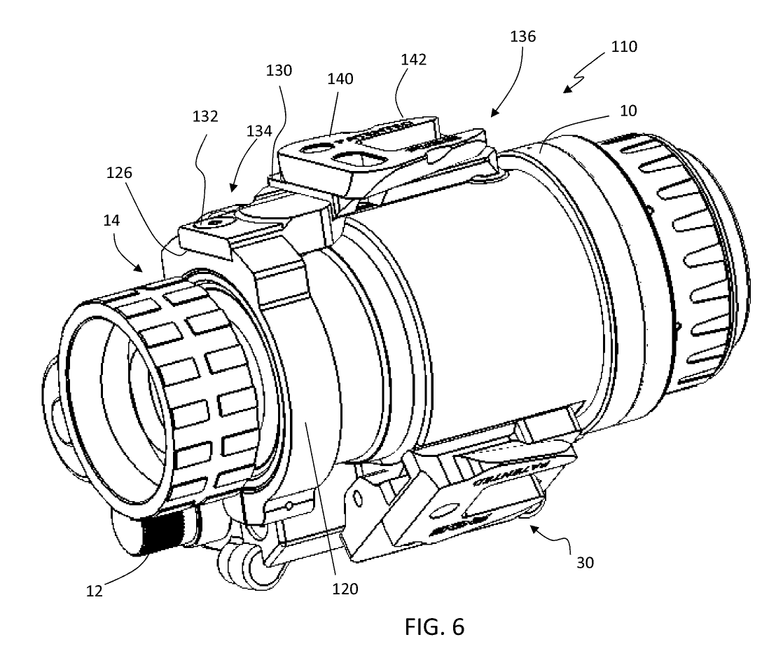

FIG. 6 is an angled side view illustration of the optical device with a floating mounting shoe apparatus of FIG. 5A, in accordance with the first exemplary embodiment of the subject disclosure.

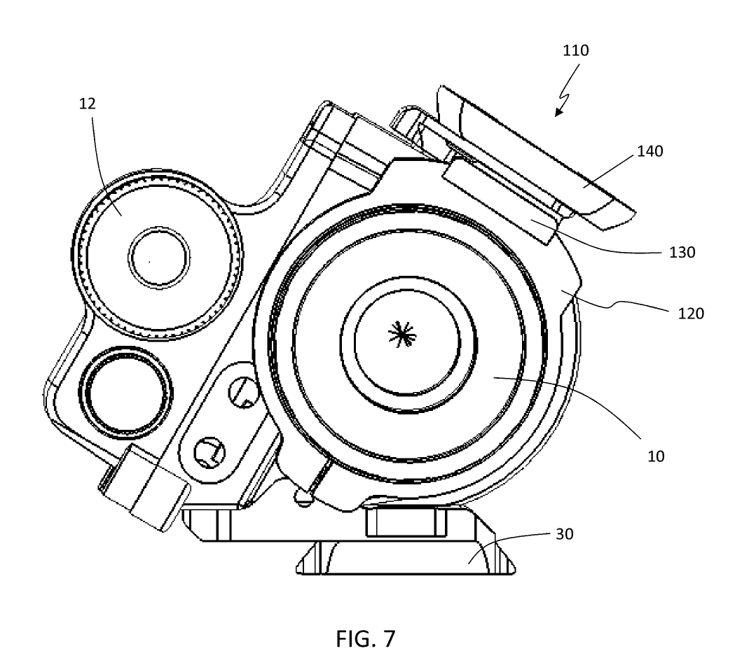

FIG. 7 is a front view illustration of the optical device with a floating mounting shoe apparatus of FIG. 6, in accordance with the first exemplary embodiment of the subject disclosure.

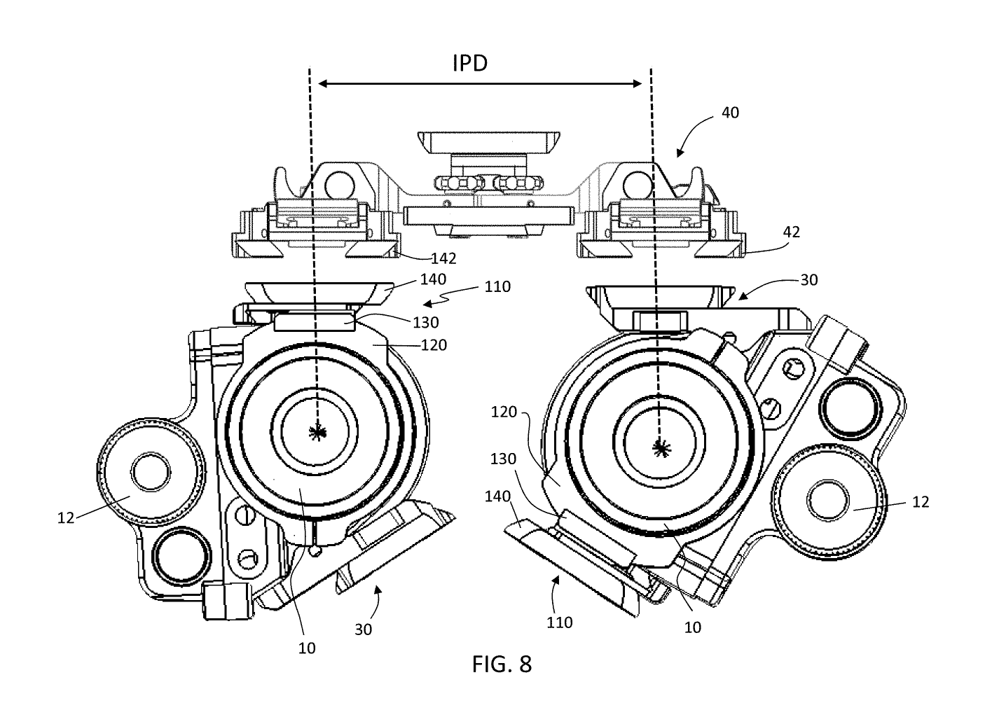

FIG. 8 is an exploded, front view illustration of a bridging device and two optical devices, in accordance with the first exemplary embodiment of the subject disclosure.

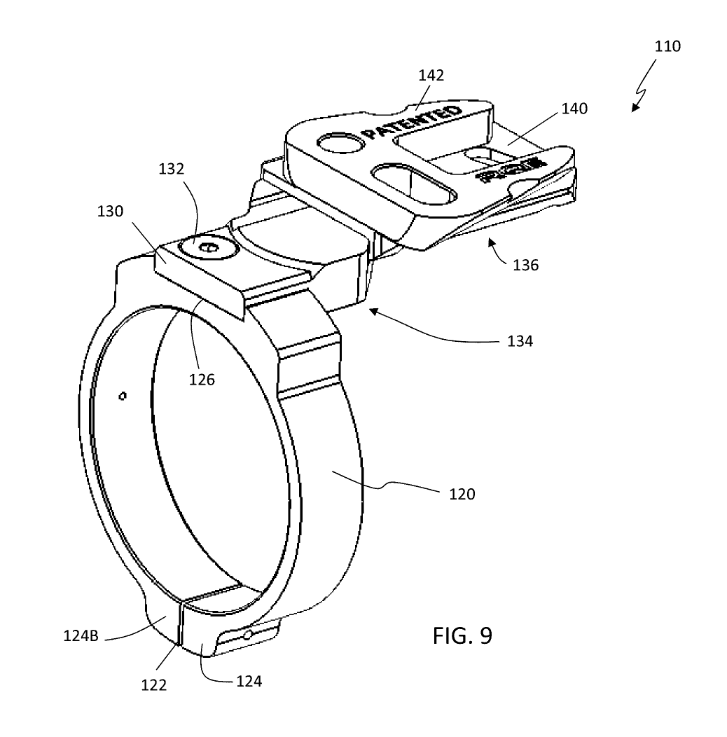

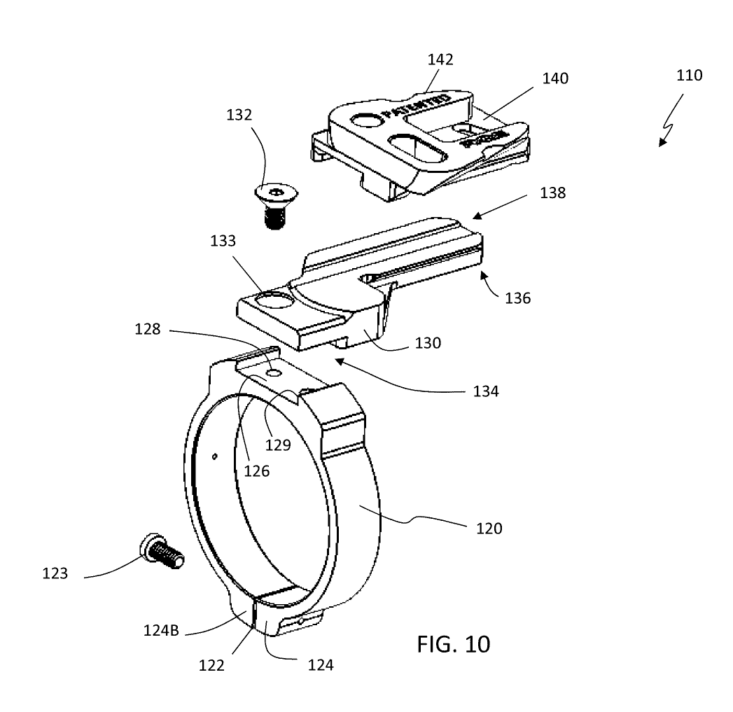

FIGS. 9-10 are isometric and isometric, exploded view illustrations of the apparatus, in accordance with the first exemplary embodiment of the subject disclosure.

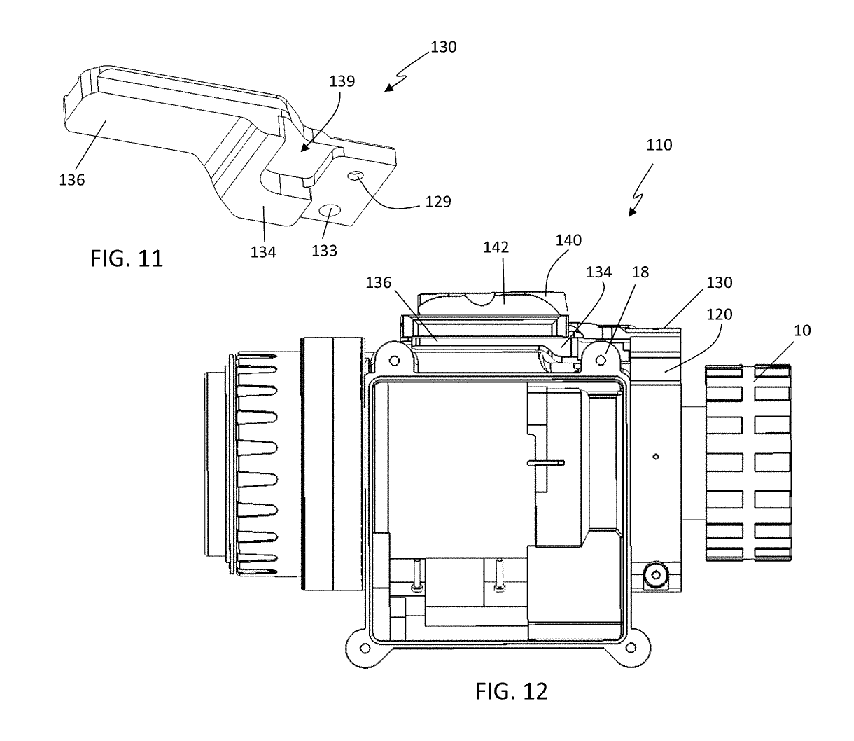

FIG. 11 is an underside view of the extension arm, in accordance with the first exemplary embodiment of the subject disclosure.

FIG. 12 is side cross-sectional view of the apparatus with an optical device, in accordance with the first exemplary embodiment of the subject disclosure.

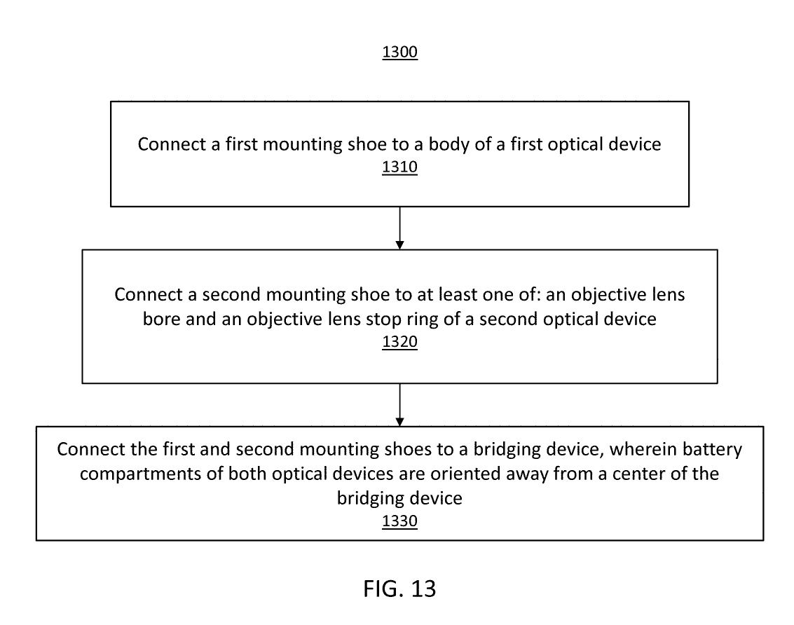

FIG. 13 is a flow chart illustrating a method of positioning two optical devices for binocular use, in accordance with the first exemplary embodiment of the subject disclosure.

### DETAILED DESCRIPTION

To overcome the shortcomings of the conventional devices identified in the background, the subject invention allows a user to utilize two monocular optical devices 10 in a side-by-side/binocular configuration by allowing one of the optical devices 10 to be mounted in an axially rotated position, such that the correct IPD can be achieved without the battery compartment 12 contacting the other optical device 10. To achieve this position, the subject invention relies on hardware components which allow one or more of the optical devices 10 to be mounted to a helmet mount or other mounting structures without using the traditional mounting shoe 30 engaged with the threaded cavity 20 of the body of the optical device 10.

FIG. 4 is an angled side view illustration of the optical device 10 with a floating mounting shoe apparatus 110 (hereinafter, “apparatus 110”), in accordance with a first exemplary embodiment of the subject disclosure. In particular, FIG. 4 illustrates a first position or stage of using the apparatus 110. In comparison to the illustration of the optical device 10 of FIG. 2, the optical device 10 in FIG. 4 has been axially rotated, such that the conventional mounting shoe 30 which is shown on the top of the optical device 10 in FIG. 2 is now positioned towards a lower portion of the optical device 10 in FIG. 4. This positioning is achieved by simply rotating the optical device 10 so that a different radial side of the optical device 10 is exposed.

Next, a collar 120 is positioned at least partially around the optical device 10, and in particular, around a lens bore or lens stop ring 14 of the optical device 10. In one example, the collar 120 may be used with an objective lens bore or objective lens stop ring 14 of the optical device 10, or in other examples, the collar 120 may be used with other lens bores, stop rings, or other structures on the optical device 110, all of which are considered within the scope of the present disclosure. For clarity in disclosure, the description herein is provided relative to use with an objective lens bore or objective lens stop ring 14 of the optical device 10. Regardless of the collar's 120 connection to the objective lens bore or objective lens stop ring 14, the objective lens therein is still permitted to move as needed during operation of the optical device 10, and the conventional utility of the objective lens stop ring to stop movement of the objective lens is not hindered. The collar 120 may be manufactured from a durable material which can be secured about the optical device 10. In one example, the collar 120 is a split ring design manufactured from a ring structure with a separation 122 therein, such that two ends 124A, 124B of the collar 120 can be removably attached together using various fasteners (not visible). This design can allow the inside diameter of the collar 120 to be slightly enlarged when it is being positioned on the optical device 10. When the collar 120 has the correct position, the fastener can be tightened to decrease the inside diameter of the collar 120 to secure it in place on the optical device 10. The collar 120 may also be positioned over existing collars on the optical device 10. The use of the split ring design for the collar 120 may capitalize on the pressure and material of the three structures over which the collar 120 is placed: the objective lens stop ring positioned over the objective bore, which is positioned over the object lens barrel. Along the exterior radial surface at the top side of the collar 120, the collar 120 may include a flattened section 126 with raised edges. The flattened section 126 may include a threaded hole 128 for receiving a fastener. Other designs of the collar 120 may include a compressed split ring design which does not require fasteners to secure the collar 120 to the optical device 10 or a collar 120 design which includes radial set screws to mount the collar 120 to the object lens stop ring in lieu of a split ring design.

FIG. 5A is an angled side view illustration of the optical device 10 with a floating mounting shoe apparatus 110 of FIG. 4, in accordance with the first exemplary embodiment of the subject disclosure. In particular, FIG. 5A illustrates an extension ann 130 connected to the collar 120 with a threaded fastener 132 which is engagable with the threaded hole (128 in FIG. 4) of the collar 120. As shown, the extension arm 130 has a first end 134 which is connected to the collar 120 and a second end 136 which extends laterally away from the collar 120, i.e., along a position above the main body of the optical device 10. The second end 136 of the extension arm 130 is capable of being retained in an elevated, non-contacting position to the optical device 10 when the collar 120 is secured to the optical device 10. The first end 134 of the extension arm 130 may be sized to fit on the flattened section 126 of the collar 120 and between the edges of the flattened section 126, to prevent rotational movement of the extension arm 130 about the fastener 132. Additionally, while not visible in FIG. 5A, a pin may also be used to secure the extension arm 130 to the flattened section 126, as discussed relative o FIGS. 10-11. The size, shape, and contour of the extension arm may vary, but it may commonly have a narrowing width along its elongated axis and rail features 138 to allow for engagement with a mounting shoe. The extension arm 130 may be manufactured from various materials and by various methods, including 3D printing.

FIG. 5B is a side view illustration of the optical device 10 with a floating mounting shoe apparatus 110, in accordance with the first exemplary embodiment of the subject disclosure. In particular, FIG. 5B illustrates the extension ann 130 connected to the collar 120 as shown in FIG. 5A. The extension arm 130 is positioned in a spaced, non-contacting position to the optical device 10, leaving a gap 131 between the extension arm 130 and the optical device 10. The gap 131 allows the extension arm 130 of the apparatus 110 to float without touching the body of the optical device.

Next, FIG. 6 is an angled side view illustration of the optical device 10 with a floating mounting shoe apparatus 110 of FIG. 5A, in accordance with the first exemplary embodiment of the subject disclosure. In particular, FIG. 6 illustrates the same components as FIG. 5A with the addition of a mounting shoe 140 which is connectable to the second end 136 of the extension arm 130. The mounting shoe 140 may include a corresponding rail engagement feature which allows it to be slid on to the extension arm 130 and secured in place by various means. The mounting shoe 140 has a shoe body 142 which may have the same shape as the conventional shoe body (32 in FIG. 2), such that the mounting shoe 140 can be used with existing mounting shoe receivers on helmets or other mounting structures. The extension arm 130 may be of a suitable length to allow the mounting shoe 140 to be connected at the same radial position along the optical device 10 as the conventional mounting shoe device 30. In other words, whether the optical device 10 is mounted by the conventional mounting shoe device 30 or the apparatus 110, the optical device 10 may retain the same spatial distance from a user's eye.

FIG. 7 is a front view illustration of the optical device 10 with a floating mounting shoe apparatus 110 of FIG. 6, in accordance with the first exemplary embodiment of the subject disclosure. As can be seen, the optical device 10 of FIG. 7 has both the conventional mounting shoe device 30 positioned on one radial side of the optical device 10, and the apparatus 110 positioned on another radial side of the optical device. For instance, the conventional mounting shoe device 30 may be positioned at a radial side on one end of the battery compartment 12. The apparatus 110 may be positioned at a radial side on the other end of the battery compartment 12. It should be noted that in this configuration, the apparatus 110 may be oriented substantially orthogonal to the battery compartment 12 of the optical device 10. This orientation may allow the battery compartment 12 a maximum degree of angular rotation away from its position relative to the conventional mounting shoe device 30. Using this configuration, the battery compartment 12 of the optical device 10 may be positioned off to the side when mounted. In another example, the apparatus 110 may be positioned at a radial side closer to the conventional mounting shoe device 30. While the conventional mounting shoe 30 is secured to the optical device 10 using the standard ¼-20 threaded cavity, the apparatus 110 is secured with the collar 120 which is positioned around the lens of the optical device 10, The extension arm 130 and mounting shoe 140 are then connectable to the collar 120.

As can be understood from FIG. 7, it is now possible to mount the optical device 10 by either using the conventional mounting shoe 30 or the apparatus 110, such that the user can select how to orient the optical device 10 on the mounting structure. Specifically, the user can select whether the battery compartment 12 is positioned on the left or right side of the optical device 10, which allows the user to choose a positioning of the optical device 10 which does not contact a second optical device (not shown) when attempting a side-by-side/binocular use. Accordingly, the apparatus 110 adds a second location for mounting the optical device 10 and the specific location of the apparatus 110 gives the user the ability to use two optical devices 10 at once. The separation between the radial sides of the conventional shoe device 30 and the apparatus 110 may be enough to orient the battery compartment 12 of the optical device 10 away from the center of the mounting bridge 40.

FIG. 8 is an exploded, front view illustration of a bridging device 40 and two optical devices 10, in accordance with the first exemplary embodiment of the subject disclosure. As shown, the left hand optical device 10 is positioned to be mounted to the left hand receiver 42 of the bridging device 40 with the apparatus 110 while the right hand optical device 10 is positioned to be mounted to the right hand receiver 42 of the bridging device 40 with the conventional mounting shoe 30. Both optical devices 10, however, may be outfitted with both the apparatus 110, including the collar 120, extension arm 130, and mounting shoe 140, and the conventional mounting shoe 30, such that the user has flexibility in choosing how to mount the optical devices 10. As can be seen in FIG. 8, in comparison to FIG. 3 of the prior art, when the apparatus 110 is used, the battery compartment 12 of the left hand optical device 10 can be positioned on the outer side of the assembly, not in the middle as shown in FIG. 3, which allows both optical devices 10 to be mounted in the side-by-side/binocular configuration. In this arrangement, it is possible to achieve the necessary IPD required by virtually any user, as the battery compartments 12 of the left and right hand optical devices 10 are oriented away from the center of the bridging device. In one example, the battery compartments 12 may he oriented toward the outside of the bridging device 40, as shown in FIG. 8. This configuration may provide space for a user's nose or any facial equipment the user may be wearing. In another example, the battery compartments 12 may be oriented downward, away from the bridging device 40. In another example, the battery compartments 12 may be oriented away fromeach other enough that the distance between the interior sides of the left and right hand optical devices 10 is less than the width of a battery compartment 12 of either optical device 10, This configuration may allow the mounted devices 10 to be closer together than if the traditional mounting shoe apparatus 30 was used alone.

FIGS. 9-10 are isometric and isometric, exploded view illustrations of the apparatus 110, in accordance with the first exemplary embodiment of the subject disclosure. In particular, FIGS. 9-10 illustrate the components of the apparatus 110 without the optical device 10. As shown, the collar 120 includes a substantially circular inside shape, the diameter of which may be adjustable by the split 122 therein, such that the fastener 123 can be used to adjustably engage the ends 124A, 124B of the collar 120. The first end 134 of the extension arm 130 may engage with the flattened section 126 of the collar 120 with a fastener 132 which is positioned through a hole 133 within the extension arm 130 and engages the threaded hole 128 of the flattened section 126. A pin and hole system 129, i.e. a protruding pin from the extension arm 130 which engages in a hole on the flattened section 126, may also be used to provide an engagement between the flattened section 126 and the underside of the extension arm 130 at the first end 134. The figures also illustrate the mounting shoe 140 with shoe body 142 which can be positioned on the extension arm 130 using a rail system 138, thereby allowing the mounting shoe 140 to slide over the second end 136 of the extension arm 130.

FIG. 11 is an underside view of the extension arm 130, in accordance with the first exemplary embodiment of the subject disclosure. FIG. 12 is side cross-sectional view of the apparatus 110 with an optical device 10, in accordance with the first exemplary embodiment of the subject disclosure. With reference to FIGS. 11-12, it can he seen how the shape and contour of the extension arm 130 can be matched to fit on the optical device 10 without interference with the shape and contour of the optical device 10 itself. In particular, the extension arm 130 may include a recessed channel 139 which is provided to allow appropriate clearance for the upper mound 18 of the optical device 10 when the apparatus 110 is positioned on the optical device 10 (the upper mounds 18 arc illustrated in FIG. 4 but not labeled). This recessed channel 139 may allow for the extension arm 130 to be positioned above the optical device 10 in the elevated, floating configuration (not in direct contact with the body of the optical device 10) while being able to position the mounting shoe 140 close to the body of the optical device 10 to achieve the correct alignment of the optical device 10 to a user's line of sight.

FIG. 13 is a flow chart 1300 illustrating a method of positioning two optical devices for binocular use, in accordance with the first exemplary embodiment of the subject disclosure. It should be noted that any process descriptions or blocks in flow charts should be understood as representing modules, segments, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

Step 1310 includes connecting a first mounting shoe to a body of a first optical device. The first mounting shoe may be connected to the body in the conventional manner and in the conventional location, as discussed relative to FIG. 2, above.

Step 1320 includes connecting a second mounting shoe to at least one of: an objective lens bore and an objective lens stop ring of a second optical device. The second mounting shoe may be connected to the second optical device as discussed relative to FIGS. 4-6, above. A collar may be positioned around the objective lens bore or the objective lens stop ring of the second optical device. The collar may allow the objective lens bore and the objective lens stop ring to remain movable during operation of the optical device. An extension arm may be connected to the collar in a spaced, non-contacting position extending laterally along the second optical device. The second mounting shoe may be connected to the extension arm,

Step 1330 includes connecting the first and second mounting shoes to a bridging device, wherein battery compartments of both optical devices are oriented away from a center of the bridging device. The mounting shoes may be connected to the bridging device as discussed in FIG. 8, above, with the first optical device connected to a right hand side and the second optical device connected to a left hand side. The bridging device may include shoe receivers for receiving the first and second mounting shoes. The center of the bridging device may be the direction between the shoe receivers, and the battery compartments of the first and second optical devices may be oriented away from that point.

In one example, the second optical device may also include a first mounting shoe as described in step 1310. The first mounting shoe may be connected to the second optical device in the conventional manner, while the second mounting shoe may be connected to the second optical device in the manner described above. This may allow a user more versatility in using the second optical device, for instance, when switching it between a head-mounted operation and a weapon-mounted operation. Or, it may enable a user to switch the second optical device between the left and right eye positions more easily. In another example, the first optical device may also include a second mounting shoe connected to the first optical device in the manner described in step 1320. This may provide the same versatility benefits described relative to the second optical device. The first optical device may include both the first and second mounting shoes. In another example, the first and second optical devices may both include first and second mounting shoes connected to them. This configuration may allow either optical device to be quickly swapped between left and right eye positions or between head-mounted operation and weapon-mounted operation.

The first and second mounting shoes may be connected to different radial sides of the first and second optical devices. For instance, the first mounting shoe may be connected along a radial side at one end of the battery compartment of the first optical device. The second mounting shoe may be connected along a radial side at another end of the battery compartment of the second optical device. This allows the battery compartments of the first and second optical devices to be oriented differently when mounted. The placement of the second mounting shoe causes the battery compartment of the second optical device to rotate away from the center of the bridging device. When the battery compartments of the first arid second optical devices are oriented away from the center of the bridging device, the interior sides of the optical devices may be mounted closer together. The interior sides of the first and second optical devices may be the sides oriented toward the center of the bridging device and relatively opposite from the battery compartments. When mounted in this configuration, the distance between the interior sides of the first and second optical devices may be less than the width of the battery compartment when the optical device is connected to the bridging device. In one example, this may allow an interpupillary distance between the first and second optical devices to be between 52 mm and 78 mm.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A floating mounting shoe apparatus for use with an optical device comprising:
a collar securable at least partially surrounding at least one of: a lens bore of an optical device and a lens stop ring of the optical device;
an extension arm having a first end connectable along an outer radial surface of the collar and a second end extending laterally away from the collar, wherein the second end is positionable in a spaced, non-contacting position to the optical device when the collar is secured to the optical device; and
a mounting shoe connectable to the second end of the extension arm.

2. The apparatus of claim 1, wherein the extension arm is engaged with a flattened section of the collar.

3. The apparatus of claim 1, wherein a battery compartment of the optical device is oriented substantially orthogonal to the mounting shoe.

4. The apparatus of claim 1, wherein the mounting shoe is connected to the extension arm at a different radial side from a second mounting shoe on the optical device.

5. The apparatus of claim 1, wherein the mounting shoe is connected to a top surface of the extension arm.

6. The apparatus of claim 1, wherein the extension aim further comprises a recessed channel in a non-contacting position over the optical device.

7. A binocular mounting system, comprising:
a first optical device having a first mounting shoe connected thereon;
a second optical device having:
a collar securable at least partially surrounding at least one of: a lens bore of the second optical device and a lens stop ring of the second optical device;
an extension arm having a first end connectable along an outer radial surface of the collar and a second end extending laterally away from the collar, wherein the second end is positionable in a spaced, non-contacting position to the second optical device when the collar is secured to the second optical device; and
a second mounting shoe connected to the second end of the extension arm; and
a bridging device having a first receiverand a second receiver, wherein the first optical device is connected to the first receiver by the first mounting shoe, and wherein the second optical device is connected to the second receiver by the second mounting shoe.

8. The system of claim 7, wherein the first optical device has a collar, extension arm, and second mounting shoe identical to the second optical device, wherein the second optical device has a first mounting shoe identical to the first optical device, and wherein the first and second optical devices are connectable to the first and second receivers by one of: the first mounting shoe and the second mounting shoe of each optical device.

9. The system of claim 7, wherein the extension arm is engaged with a flattened section of the collar.

10. The system of claim 7, wherein a battery compartment of the second optical device is oriented substantially orthogonal to the second mounting shoe.

11. The system of claim 7, wherein battery compartments of the first and second optical devices are oriented away from a center of the bridging device.

12. The system of claim 7, wherein a distance between an interior side of the first optical device and an interior side of the second optical device is less than a width of a battery compartment of either optical device.

13. The system of claim 7, wherein an interpupillary distance between the first and second optical devices is between 52 mm and 78 mm.

14. The system of claim 7, wherein a lens and the lens stop ring of the second optical device are movable during operation of the second optical device.

15. The apparatus of claim 7, wherein the extension arm further comprises a recessed channel in a non-contacting position over the optical device.

16. A method of positioning two optical devices for binocular use, comprising the steps of:
connecting a first mounting shoe to a body of a first optical device;
connecting a second mounting shoe to at least one of: a lens bore of a second optical device and a lens stop ring of the second optical device; and
connecting the first and second amounting shoes to a bridging device, wherein battery compartments of both optical devices are oriented away from a center of the bridging device.

17. The method of claim 16, wherein the first mounting shoe and the second mounting shoe arc connected to different radial sides of the first and second optical devices, respectively.

18. The method of claim 16, wherein a distance between an interior side of the first optical device and an interior side of the second optical device is less than a width of the battery compartment of either optical device when connected to the bridging device.

19. The method of claim 16, wherein an interpupillary distance between the first and second optical devices is between 52 mm and 78 mm.

20. The method of claim 16, wherein a lens and the lens stop ring of the second optical device are movable during operation of the second optical device.
